(19) United States
(12) Patent Application Publication
(10) Pub. No.: US 2003/0014941 A1
(43) Pub. Date: Jan. 23, 2003

(54) Stone door

(75) Inventor: Carlo Mazza, Sondrio (IT)

Correspondence Address: MODIANO & ASSOCIATI, Via Meravigli, 16, 20123 MILANO, IT

(73) Assignee: BEBSTONE S.R.L.

(21) Appl. No.: 10/190,711

(22) Filed: Jul. 9, 2002

(30) Foreign Application Priority Data
Jul. 19, 2001 (IT) MI2001A001540

(51) Int. Cl. E06B 3/00

(52) U.S. Cl. 52/784.11

(57) ABSTRACT

A stone door comprising a door body formed by a panel that forms a cellular structural core with plate-like elements made of stone on both faces. The structural core is provided perimetrically with a milling to accommodate an insert for the coupling of door connection accessories.

### BACKGROUND OF THE INVENTION

The present invention relates to a stone door.

As is known, doors and windows, such as internal doors and the like, are currently made of various materials, such as wood and metal, but up to now it has not been possible to produce a door with a stone cladding, both because of the considerable weights involved and because it has not been possible to provide a structure that supported correctly plate-like elements made of stone.

Panels are also known which are used for claddings and are produced by means of a cellular or honeycomb panel, mats of glass fiber, aluminum, Kevlar and so forth, with which a layer of stone has been associated. In practice, a stone slab is coupled by adhesive bonding to a supporting structure, for example a cellular panel, which by having extremely high-level mechanical characteristics of strength and elasticity allows the stone to act solely as an external finishing layer, privileging its aesthetic qualities in terms of appearance and its physical qualities in terms of surface hardness.

To provide this solution and obtain layers of stone with a thickness between 5 and 7 mm, currently supporting structures made of cellular panels are coupled to a 2-cm stone slab, on both faces, and the slab is cut by means of a diamond wire, thus obtaining two panels for each production cycle.

Another known solution entails cutting a block directly on a frame to a low thickness and then coupling it by way of glass fibers and the like.

Another solution is constituted by the removal of the excess thickness by polishing.

All currently known solutions have merely produced a single face with the stone and therefore they are not feasible for producing doors, also in view of the fact that difficulties were encountered in connecting accessories such as hinges, handles and so forth.

### SUMMARY OF THE INVENTION

The aim of the present invention is to eliminate the drawbacks noted above, by providing a stone door in which it is possible to have a uniform and structurally strong assembly that allows to provide a door with acceptable weights and with the appropriate assurances of mechanical strength.

Within this aim, a particular object of the invention is to provide a door in which it is possible to have optimum characteristics as regards both the aesthetic finish and the mechanical strength of the assembly.

Another object of the present invention is to provide a stone door that by way of its particular constructive characteristics is capable of giving the greatest assurances of reliability and safety in use.

Another object of the present invention is to provide a door that can be obtained easily starting from commonly commercially available materials and is further assuredly innovative for the commercial field in which it is placed.

This aim and these and other objects that will become better apparent hereinafter are achieved by a stone door, according to the invention, characterized in that it comprises a door body formed by a panel that has a cellular structural core with plate-like elements made of stone on both faces, said structural core being provided perimetrically with a milling to accommodate an insert for the coupling of door connection accessories.

### BRIEF DESCRIPTION OF THE DRAWINGS

Further characteristics and advantages of the present invention will become better apparent from the following detailed description of a preferred but not exclusive embodiment of a stone door, illustrated only by way of non-limitative example in the accompanying drawings, wherein:

FIG. 1 is a schematic perspective view of a door according to the invention;

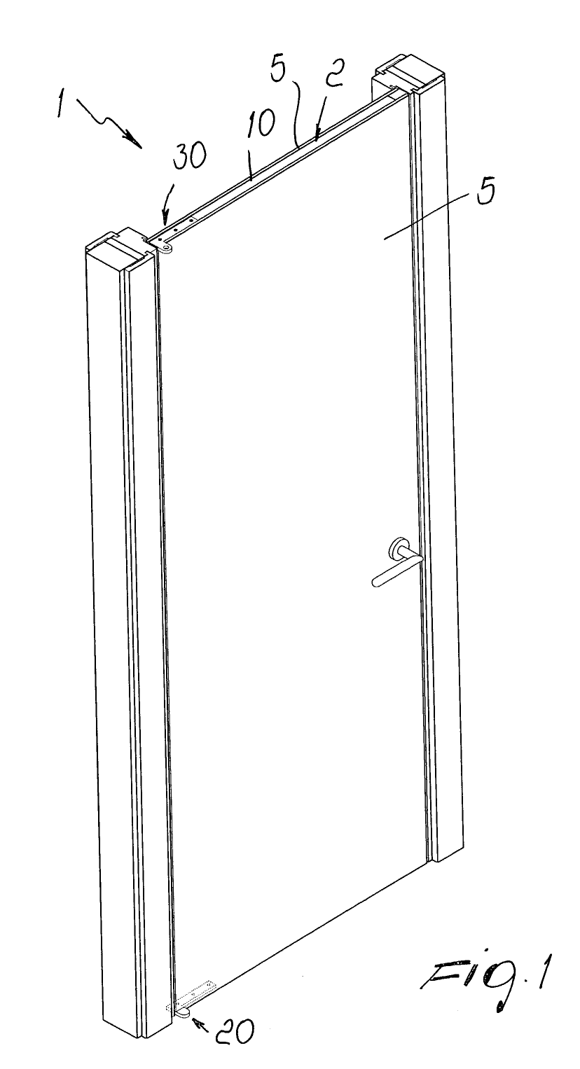

FIG. 2 is sectional view of the door, taken along a transverse plane;

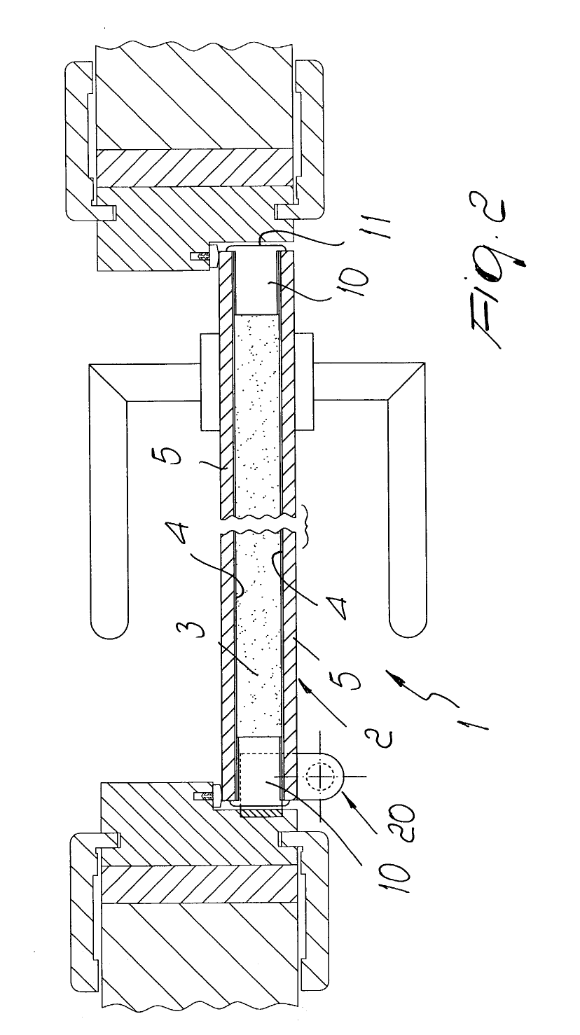

FIG. 3 is a schematic exploded view of the door;

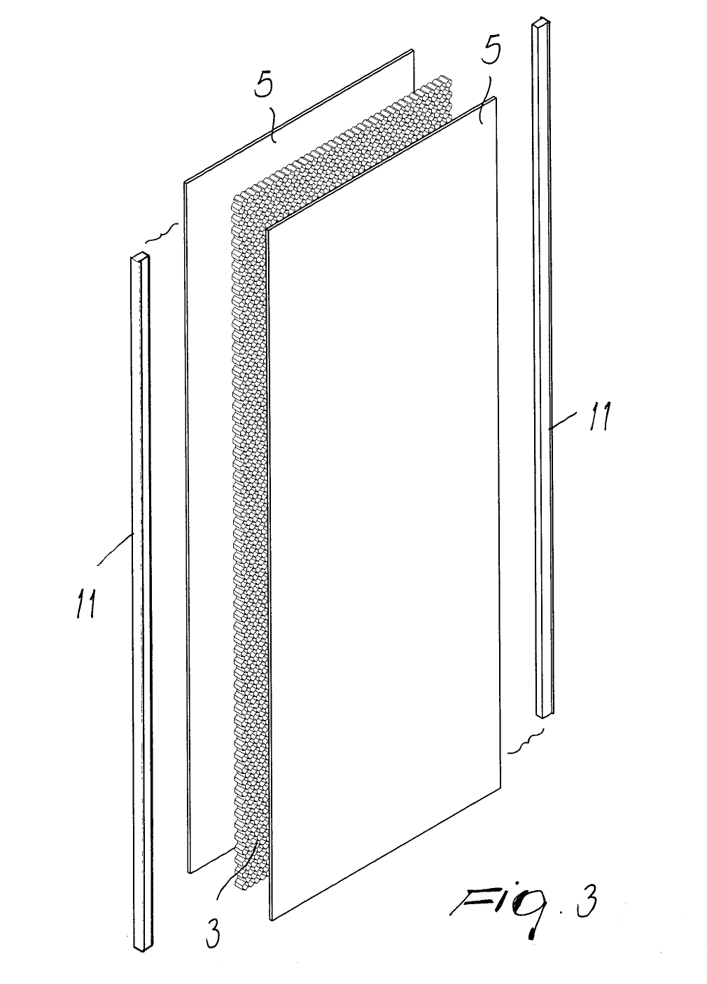

FIG. 4 is a view of the panel that forms the door;

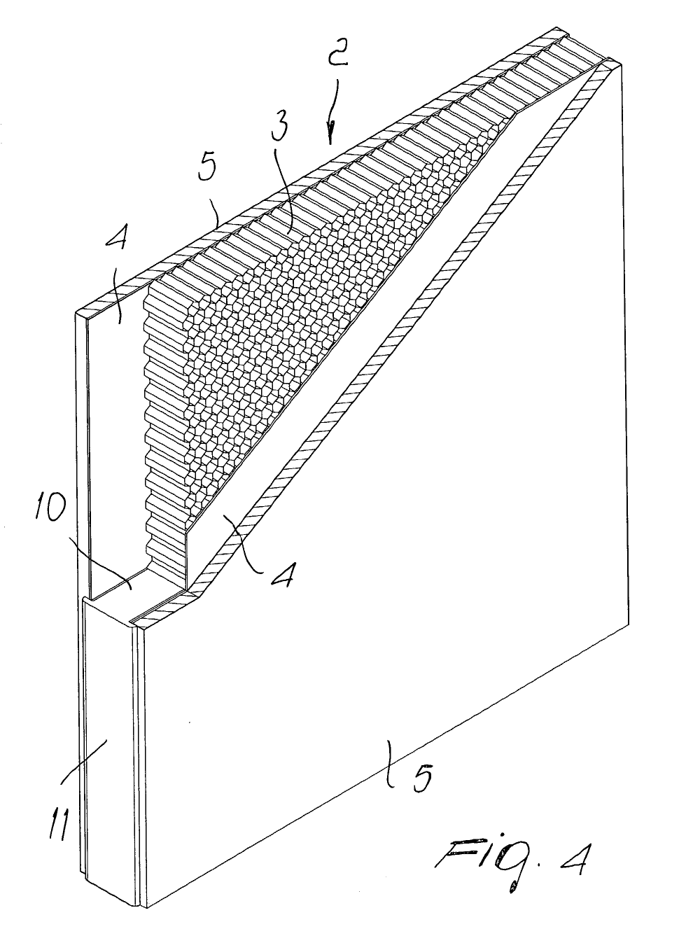

FIG. 5 is a view of an optimum solution for the hinges.

### DESCRIPTION OF THE PREFERRED EMBODIMENTS

With reference to the figures, a stone door according to the invention, generally designated by the reference numeral 1, comprises a door body formed by means of a panel 2 that has a cellular structural core 3.

Preferably, the structural core has a polypropylene cellular structure with a density of 80 kg/m³, on the faces of which glass fiber mats 4 are bonded with adhesive which have a grammage of approximately 500 g/m² and a thickness of approximately 1 mm and are impregnated with epoxy resin.

The glass fiber mats are designed to stiffen the panel and facilitate the adhesive bonding of stone plate-like elements 5.

Obviously, the structural core can also be provided by means of sandwich panels made of aluminum honeycomb or of any commercially available material having strength and light weight characteristics, such as polystyrene or polyurethane panels, glass fiber panels, and the like.

The adhesive bonding of the stone plate-like elements 5 is performed with two-part polyurethane or epoxy resins, with a quantity of approximately 600 g/m².

The plate-like elements are then brought to a thickness of 5-7 mm, depending on the material being treated, by using conventional methods. If marble is used, a measurement of approximately 7 mm is advisable, whereas when using granites and other stones a measurement of 5 mm is advisable.

A particularity of the invention is that at the perimetric region, on the structural core, there is a milling for accommodating an insert 10, which is preferably but not necessarily made of wood, is anchored in practice to the panel, and advantageously has an edge 11 that is adapted to cover the joint between the stone, the glass fiber mat, and the cellular element.

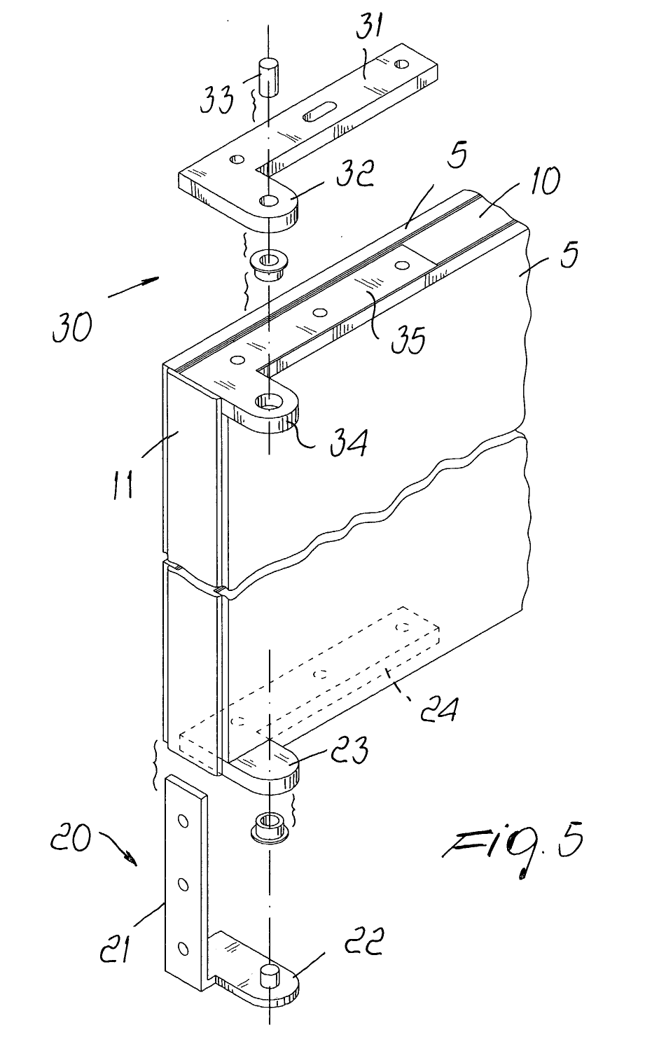

The usual recesses for inserting the lock with the corresponding handle and for connecting the hinges are provided in the insert 10; advantageously, as shown in FIG. 5, the hinges can have a lower body 20 provided with a fixed plate 21 that can be inserted in the doorjamb and a supporting foot 22 on which the lug 23 of a movable lower plate 24, recessed in the lower body of the door, is hinged.

Likewise, there is an upper portion 30 of the hinge with an upper fixed plate 31 provided with a lug 32, in which an upper pivot 33 is hinged for connection to the upper movable lug 34 of an upper plate 35, which is recessed in the upper edge of the door.

This type of hinge allows 180° opening and is very easy to install.

The described arrangement therefore provides a stone door that is provided perimetrically, on the structural core that bears the plate-like elements made of stone or stone-like material, with a wood insert that allows to connect the accessories, such as hinges, locks and the like, in a conventional manner and with high mechanical strength.

It is therefore evident from what has been described above that the invention achieves the proposed aim and objects, and in particular the fact is stressed that the stone door allows to have an assembly that is perfectly strong from a mechanical standpoint and also has a very high level of aesthetic finish.

The invention thus conceived is susceptible of numerous modifications and variations, all of which are within the scope of the inventive concept.

All the details may further be replaced with other technically equivalent elements.

In practice, the materials used, as well as the dimensions, may be any according to requirements.

The disclosures in Italian Patent Application No. MI2001A001540 from which this application claims priority are incorporated herein by reference.

What is claimed is:

1. A stone door, comprising a door body formed by a panel that has a cellular structural core with plate-like elements made of stone on both faces, said structural core being provided perimetrically with a milling to accommodate an insert for the coupling of door connection accessories.

2. The door according to claim 1, comprising, between said cellular structural core and said plate-like elements made of stone material, mats made of glass fiber.

3. The door according to claim 1, wherein said plate-like elements made of stone are connected to said structural core by interposing an adhesive layer.

4. The door according to claim 1, wherein said plate-like elements made of stone have a thickness between 5 and 7 mm.

5. The door according to claim 1, wherein said insert has an edge that is suitable to act as a cover for a joint between the plate-like element, the stone and the cellular structural core.

6. The door according to claim 1, wherein said insert is made of wood.

7. The door according to claim 1, further comprising hinges that have a lower body constituted by a fixed plate that can be connected to the jamb and a supporting foot on which the lug of a movable lower plate is hinged, said movable lower plate being recessed in the lower body of the door, there being also an upper body which has an upper portion of the hinge with an upper fixed plate provided with a lug in which an upper connecting pivot of an upper movable lug is hinged, said upper lug being formed by an upper plate recessed in the upper edge of said door.
